(19) United States
(12) Patent Application Publication
(10) Pub. No.: US 2002/0193267 A1
(43) Pub. Date: Dec. 19, 2002

(54) Composition and method for purging polymer processing equipment

(75) Inventor: Norman E. Nitzsche, Willard, OH (US)

Correspondence Address: Woodrow W. Ban, PolyOne Corporation, 33587 Walker Road, Avon Lake, OH, 44012, US

(73) Assignee: PolyOne Corporation

(21) Appl. No.: 10/126,312

(22) Filed: Apr. 19, 2002

Related U.S. Application Data
(63) Continuation-in-part of application No. 09/844,459, filed on Apr. 27, 2001, now Pat. No. 6,384,002.

(51) Int. Cl. C11D 1/00

(52) U.S. Cl. 510/188; 510/475

(57) ABSTRACT

A composition and method purge resin deposits from the inner surfaces of polymer processing machinery upon the flow of a stream of resin through the polymer processing machinery. The composition includes a mixture of purging agents separate from the resin that are poured into the stream of resin as an additive. The purging agents include a blowing agent to induce foaming of the stream of resin and an abrasive to scrub the resin deposits from the inner surfaces of the polymer processing machinery. The purging agents further include a surfactant to promote the flow of the stream of resin along the inner surfaces of polymer processing machinery. A binder binds the purging agents together in the mixture. The method includes feeding a mixture comprised of a blowing agent, an abrasive, a surfactant, and a binder into the stream of resin entering the polymer processing equipment.

### CROSS REFERENCE

This application is a continuation-in-part of prior application Ser. No. 09/844,459, filed Apr. 27, 2001, entitled “A Composition and Method for Purging Polymer Processing Equipment.”

### FIELD OF THE INVENTION

The present invention relates to a purging composition for polymer processing equipment. A method for removal of deposits from the inner surfaces of polymer processing machinery utilizing the purging composition is also disclosed. A suitable process for preparation of the compositions is also described. The purging compositions contain various components which can physically and chemically interact with the deposits to be removed from the processing equipment.

### BACKGROUND OF THE INVENTION

Thermoplastic or thermosetting polymeric material or resin is typically processed in processing equipment, such as injection molders or extruders. The polymeric materials typically introduced or fed into the processing equipment are in a granular or pellet form which is subsequently heated above its melting point and formed into a final product. As known in the art, the polymeric materials can be colored with pigments or other colorants in order to provide the final product with a desired appearance.

During processing from an inlet to an outlet of the processing equipment, material can accumulate in various internal surface locations thereof. Over time the accumulated material can be degraded from exposure to the heat of the equipment. It is desirable to purge these deposits from the internal surfaces of the equipment.

Moreover, polymeric processors often produce final products of various colors. A purging composition can be added to the processing equipment between color runs to purge the prior color deposits and prepare the equipment for a next color.

### SUMMARY OF THE INVENTION

The present invention provides a composition for purging resin deposits from the inner surfaces of polymer processing machinery upon the flow of a stream of polymeric material or resin through the polymer processing machinery. The composition includes a mixture of purging agents separate from the resin in a state pourable into the stream of resin as an additive. The purging agents include a blowing agent which induces foaming of the polymer resin, and an abrasive effective to scrub deposits from the inner surfaces of the polymer processing machinery. The purging agents further include a surfactant effective to promote the flow of the stream of resin along the inner surfaces of the polymer processing machinery. A binder binds the purging agents together in the mixture.

The present invention also provides a method for purging resin deposits from the processing or inner surfaces of polymer processing machinery. The method includes feeding a mixture comprising a blowing agent, an abrasive, a surfactant, and a binder into the stream of resin in the polymer processing equipment.

### DESCRIPTION OF THE INVENTION

The invention is a purge composition, and a method of use, that enables polymeric material or resin deposits to be removed from the inner surfaces of polymer processing equipment. The purge composition is in a concentrated form and is generally added at a desired ratio to a polymeric material or resin before or during addition to polymer processing machinery. The purge composition functions by scrubbing old resin deposits and other debris from the inner surfaces of the polymer processing machinery during a normal production cycle. Preferably, the purge composition is formulated to be most active over a temperature range that corresponds to the actual operating temperature range of the processing machinery. Numerous different formulations are described for the purge compositions. The compositions of the present invention advantageously can be utilized on machinery that is operating at low, standard, or high processing temperature ranges or anywhere therebetween.

The purging compositions of the present invention comprise various components including blowing agents, abrasives, binders, and surfactants. The compositions are preferably prepared utilizing a cold compression molding process, wherein the components such as the blowing agents are kept below temperature wherein the same would be activated or degraded.

Blowing or foaming agents are utilized in the composition of the present invention. Blowing agents can be endothermic, exothermic, or a combination thereof. The specific blowing agent utilized is selected to be active at or below the processing temperature or range of the polymeric material being processed. Typical blowing agents, when activated, evolve or produce a gas such as nitrogen or carbon dioxide. As the gas evolves, the volume of the composition-polymeric material mixture expands within the processing device, resulting in the expansion of the mixture against the inner surfaces of the machinery causing an increase in the scrubbing action of the mixture which aids in the removal of the resin deposits. In order to prevent the blowing agent from prematurely activating or decomposing, the concentrate compositions are processed and preferably formed into particles such as pellets below the activation temperature of the blowing agent.

During molding of a polymeric material and a concentrate at elevated temperatures sufficient to degrade or activate the blowing agent, endothermic blowing agents will absorb heat as they degrade. The melt flow (polymer and composition) is placed under greater pressure by the blowing agent due to the evolution of gas. Accordingly, the pressure forces the mixture against the inner surfaces of the machinery wherein the other components of the composition, especially the abrasive component can beneficially act to cleanse the process equipment.

Suitable commercially available blowing agents available from Mats Corp. Ltd. of Markham, Ontario as MS01, Cenblo Mat 100 or 500 (a carboxylic acid and carbonate based product), or Matendo P80, Uniroyal Chemical Company, Inc. of Middlebury, Conn., as Expandex® 5PT (a 5-phenyl tetrazole based product), EPI Environmental Plastics Inc. of Conroe, Tex., as EPIcor, Uniroyal Chemical Company of Middlebury, Conn., as Expandex and Reedy International Corp. of Keyport, N.J. as Safoam.

Non-limiting examples of endothermic blowing agents are polycarbonic acids, coated sodium bicarbonate, coated citric acid, coated mono sodium citrate, and coated sodium citrate. Exothermic blowing agents include, but are not limited to, azodicarbonamides, modified azodicarbonamides, oxybis (benezene sulfonyl hydrazide) (OBSH), toluenesulfonylhydrazides (TSH), 5-phenyltetrazole (5-PT), diisopropylhydrazodicarboxylate (DIHC), and dinitrosopentamethylenetetramine (DNPT).

Blowing agents in general are utilized in the compositions of the present invention in amounts ranging from about 5 or about 10 to about 75 or 80 parts per 100 parts by weight of the composition, with about 25 to about 50 or about 60 parts being preferred. Endothermic blowing agents are utilized in the composition of the present invention in amounts which range generally from about 5 parts to about 50, about 60, or about 70 parts, desirably from about 25 parts to about 50 or about 55 parts, and exothermic blowing agents are utilized in amounts generally from about 5 parts to about 60 parts, and desirably from about 5 parts to about 30 or about 45 parts by weight based on 100 parts by weight of the composition.

An abrasive component is also utilized in the purge compositions of the present invention. The abrasive component advantageously has properties which can wear away by scraping, rubbing and/or grinding deposited polymeric material from the inner surfaces of the polymer processing equipment, such as an extruder barrel surface or injection screw, etc. The abrasive component generally works in a physical manner by scouring. Examples of suitable abrasive components include, but are not limited to, calcium carbonate, silica, alumina, sulfates, sulfides, talc, mica, or combinations thereof. The abrasive component can contain fine, medium, or course particles, or a distribution thereof to provide an effective abrasive action.

Examples of commercially available abrasives suitable for use in the abrasive component include, but are not limited to, Omyacarb® FT (calcium carbonate) available from Omya, Inc. and calcium carbonate available from Whittaker Clark and Daniels, talc (Talc 399) available from Whittaker, Clark and Daniels, clay (Burgess KE) available from Burgess Pigment Company, and barium sulfate (2278 Blanc Fixe) available from Whittaker, Clark and Daniels.

The abrasive component is utilized in the purge compositions of the present invention in amounts generally from about 5 or about 10 parts to about 75 parts, desirably from about 20 parts to about 70 parts, and preferably from about 25 parts to about 50 parts, based on 100 parts by weight of said composition.

The compositions of the present invention also include a surfactant component. Surfactants are generally used in the formula to de-dust and/or densify. Examples of surfactants include, but are not limited to mineral oil, castor oil, and soybean oil. The preferred surfactant is mineral oil, such as Drakeol 34 available from Pennreco. Maxsperse W-6000 and W-3000 solid surfactants are available from Chemax Polymer Additives. The surfactants can be in either solid or liquid form.

The surfactant component is utilized in the purge compositions of the present invention in amounts generally from about 1 to about 30 parts, desirably from about 2 or about 5 to about 25 parts, and preferably from about 4 to about 8 parts, based on 100 parts by weight of said composition.

A binder component is also utilized in the compositions of the present invention. The binder can beneficially “wet” the other components present and render them more dispersible in the polymeric material added with the composition to purge the processing machinery. The binder components are waxes which can be natural or synthetic. The waxes are generally solid at room temperature and have a molecular weight of less than about 10,000 weight average. The binder component is present in the compositions of the invention in amounts greater than about 10% by weight, and generally from about 10 parts to about 50 parts, and preferably from about 10 parts to about 25 parts per 100 parts by weight of the composition.

Examples of waxes suitable for the binder component of the present invention include, but are not limited to, amide waxes such as ethylene bis-stearamide wax and hydroxystearamide wax, maleated ethylene waxes, maleated propylene waxes, microcrystalline waxes, oxidized waxes, paraffin waxes, petroleum waxes, polyethylene waxes, polytetrafluoroethylene (PTFE) waxes, wax esters, wax soaps, and polycaprolactone wax, or combinations thereof. The preferred binder component is a mixture of ethylene bis-stearamide wax and hydroxystearamide wax, at a ratio of about 60% to about 40%, respectively based on the total binder component. A further preferred binder component is a mixture of polycaprolactone wax and polyolefin wax, preferably in equal amounts, or a mixture of ethylene bis-stearamide wax, hydroxystearamide wax, polycaprolactone wax, and polyolefin wax. Suitable waxes are available from E. W. Kaufman as Cerit 220 (hydroxy stearamide wax), Rohm and Haas as Advawax® 280, and Polycaprolactone CAPA PL1000 and CAPA 6506 available from Solvay Caprolactones.

The purge compositions of the present invention can optionally include at least one functional compounding additive component including, but not limited to, nucleators, activators which lower the activation temperature of the blowing agent, plasticizers, fillers, mold release aids, processing aids, antistatic additives, and lubricants. The optional components including one or any combination of the above listed components are present in the composition in an amount generally from about 0 or 1 part to about 98 parts, desirably from about 25 parts to about 50 parts, and preferably from about 10 parts to about 20 parts by weight based on 100 parts of the total composition.

Examples of commonly utilized functional compounding additives or components include clays, nano-composites, alkylated phenols and bisphenols, alkylidene bis, tris, and polyphenols, thio and di thiobis, tris and polyalkylated phenols, phenol condensation products, amines, esters, organic phosphites and phosphates, glycerol esters, quaternary ammonium compounds, anionics, alkane sulfonate, spheriglas, antimony mercaptide, berium cadmium liquids and powders, barium cadmium zinc liquids and powders, barium calcium zinc powders and liquids, barium organic, barium powder, barium zinc liquids and powders, cadmium liquids, cadmium zinc liquids, calcium powders, calcium tin zinc pastes, liquids, and powders, calcium zinc pastes, liquids, and powders, epoxies, hydroxyl amines, leads, mixed metal soaps, phenols, phosphites, single metal soaps, tins, zinc and zinc complex, catalysts, alcohol esters, complex esters, costabilizing lubricants, fatty acids, fatty acid amides, fatty acid esters, fatty alcohols, glycol esters, metallic sterates, aluminum, barium, lithium, magnesium, sodium, stannous tin, montan wax esters, polypropylene amorphous, and crystalline, silicones, wax acid, abietic derivatives, acetic acid derivative, azelatic acid derivatives, benzoic acid derivatives, butene derivative, organic fillers, urea, zinc oxide, sodium benzoate, calcium carbonate, atomite, talc, boron nitride, zinc sterate, calcium sterate, sodium benzoate, urea, zinc oxide, barium sterate, glycols, alkanolamines, oxidizing agents/peroxides, lead sterate, magnesium oxide, stearic acid, salicyclic acid, and diphenylguanidine (DPG).

The purge compositions of the present invention can be used in generally any polymer processing equipment known to the art which operate at temperatures generally from about 200° F. and above, and preferably from about 250° F. to about 600 or about 700° F. The components of the purge composition are chosen to be effective at and compatible with the predetermined processing temperature.

In a first embodiment, the purge composition is optimized for purging deposits from the polymer processing equipment that is operating at low processing temperatures, such as about 400° F. or less. This first purge composition includes an endothermic blowing agent (also known as a foaming agent), an abrasive, a low melt temperature binder, and a surfactant. The formulation for this embodiment is shown in Table 1.

TABLE 1
LOW TEMPERATURE PURGE COMPOSITION FORMULATION

| | Quantity in |
|---|---|
| Purge Agent | Formula (%) |
| MSO1Genblo Mat 500 or equivalent endothermic | 50 |
| blowing agent (e.g., coated sodium bicarbonate and | |
| citric acid) | |
| Omyacarb ® FT or equivalent small particle calcium | 33 |
| carbonate | |
| Mineral Oil or equivalent surfactant | 2 |
| Cent 220 powder or equivalent hydroxy stearamide | 15 |
| wax | |
| Total | 100% |

The preferred blowing agent in the first embodiment is the commercial product MSO1 Cenblo Mat 500 available from Mats Corp. Ltd. (Markham, Ontario, L3R Canada). MSO1 Cenblo Mat 500 is a carboxylic acid and carbonate based product. However, the formulation could include any other endothermic blowing agent which results in a purge composition which may be used to purge resin deposits as desired. Alternatively, a blowing agent could be prepared as a mixture of generic ingredients, such as a mixture of generic coated sodium bicarbonate and citric acid, or the like.

The abrasive in the first embodiment adds to the scrubbing action of the purge composition and also acts as a filler. The commercial product Omyacarb® FT available from Omya Inc. (Florence, Vt.) is the preferred abrasive in the first embodiment. Omyacarb® FT is a calcium carbonate based product. However, the formulation could include any other abrasive that would increase the scrubbing action of the purge composition for the removal of resin deposits. For example, another small particle calcium carbonate having an average particle size of not greater than about 1.5 microns can be substituted for the Omyacarb® FT. Preferably, the average particle size should be about 1.3 microns, as in the Omyacarb® FT product.

The preferred binder in the first embodiment is the commercial product Cerit 220 Powder available from E. W. Kaufman (Southamper, Pa.). Cerit 220 is a hydroxystearamide based product. A hydroxystearamide wax, or any other suitable alternative, can be substituted for the Cerit 220. Whichever binder is used, it should preferably be a low melt temperature binder which will release at approximately 220° F. The melted binder aids the incorporation of the purge composition into the melt flow of the resin. The surfactant in the first embodiment is mineral oil. However, any suitable surfactant having the ability to coat or wet out the inner surfaces of the polymer processing machinery can be substituted.

In a second embodiment, the purge composition has a more effective scrubbing action at standard processing temperatures, such as within the range of about 400° F.-500° F., whereas in the first embodiment the first composition exhibits a more effective scrubbing action at lower processing temperatures. The formulation of the second purge composition includes the same abrasives and surfactants as those included in the formulation of the first purge composition. However, the second formulation differs from the first in that the endothermic blowing agent and the binder are more appropriate for use at standard processing temperatures. The formulation for this embodiment is shown in Table 2.

TABLE 2
STANDARD TEMPERATURE PURGE COMPOSITION
FORMULATION

| | Quantity in |
|---|---|
| Purge Agent | Formula (%) |
| MSO1 Cenblo Mat 100 or equivalent | 50 |
| endothermic blowing agent (e.g., coated sodium | |
| bicarbonate and citric acid) | |
| Omyacarb ® FT or equivalent small particle | 33 |
| calcium carbonate | |
| Mineral Oil or equivalent surfactant | 2 |
| Advawax ® 280 or equivalent ethylene bis | 15 |
| stearamide wax | |
| Total | 100% |

The preferred blowing agent in the second embodiment is the commercial product MSO1 Cenblo Mat 100 available from Mats Corp. Ltd. (Markham, Ontario, L3R Canada). MSO1 Cenblo Mat 100 is a carboxylic acid and carbonate based product. However, any other endothermic blowing agent could be included in the composition as long as it results in a purge formulation capable of being used to purge resin deposits as desired. For example, a blowing agent could be prepared as a mixture of generic ingredients, such as a mixture of coated sodium bicarbonate and citric acid or the like, at a ratio effective for standard processing temperatures.

The preferred binder in the standard temperature purge composition is the commercial product Advawax® 280 available from Rohm & Haas Co. (Cincinnati, Ohio). Advawax® 280 is an N,N ethylene bis(stearamide) based product. However, an ethylene bis stearamide wax, or any other suitable alternative, can be substituted. The binder should be a low melt temperature binder which will release at approximately 280° F., thereby aiding the incorporation of the purge composition into the melt flow of the stream of resin.

The ratio of endothermic blowing agent to abrasive in both the first and second purge composition formulations is optimized to achieve a maximum scrubbing action. This optimized ratio is preferably within the range from about 1.5:1 to about 2:1.

In a third embodiment, the purge composition has a more effective scrubbing action at high processing temperatures, such as about 500° F. or higher, whereas the first and second purge compositions are more effective at low and standard processing temperatures, respectively. The third composition uses the same abrasives and surfactants as those listed for the first and second compositions. However, the third composition differs from both of the previous compositions in that it preferably uses an exothermic blowing agent and a binder than are appropriate for use at high processing temperatures. The formulation for this embodiment is shown in Table 3.

TABLE 3
HIGH TEMPERATURE PURGE COMPOSITION FORMULATION

| Purge Agent | Quantity in Formula (%) |
|---|---|
| Expandex ® 5PT or equivalent exothermic | 40 |
| blowing agent (5-Phenyl tetrazole based | |
| chemistry) | |
| Omyacarb ® FT or equivalent small particle | 43 |
| calcium carbonate | |
| Mineral Oil or equivalent surfactant | 2 |
| Advawax ® 280 or equivalent ethylene bis | 15 |
| stearamide wax | |
| Total | 100% |

The preferred blowing agent in the third embodiment is the commercial product Expandex® 5PT available from Uniroyal Chemical Company, Inc. (Middlebury, Conn.). Expandex® 5PT is a 5-phenyl tetrazole based product. However, the composition could include any other exothermic blowing agent which results in a purge composition which may be used to purge resin deposits as desired. The action of the exothermic blowing agent will preferably be based on 5-Phenyltetrazole chemistry. Alternatively, other high temperature formulations might use an endothermic blowing agent, such as Mat 201 or Mat 101 (Mats Corp. Ltd., Markham, Ontario, L3R Canada), as long as the endothermic blowing agent results in a desired level of resin deposit removal at these high temperatures. Mat 201 and Mat 101 are chemical blends of polycarbonic acids, inorganic carbonates, and stearates.

In its most preferred embodiment, the formulation for the third purge composition has an optimal ratio of exothermic blowing agent to abrasive that results in maximum scrubbing action at high temperatures. This ratio is most preferably about 1:1. The average particle size of the abrasive is the same as that noted for use in the previous formulations.

The preferred binder of the high temperature purge composition is the commercially available product Advawax® 280 (Rohm & Haas Co., Cincinnati, Ohio). Advawax® 280 is an N,N ethylene bis(stearamide) based product. However, an ethylene bis stearamide wax, or any other suitable alternative, can be substituted. The binder should be a low melt temperature binder which will release at approximately 280° F.

A further example of a purge composition suitable at least for high temperature processing range is set forth in Table 4 below. An endothermic blowing agent is utilized in this formulation.

TABLE 4
HIGH TEMPERATURE PURGE COMPOSITION FORMULATION

| | |
|---|---|
| Matendo P80 (exothermic blowing agent) | 50 |
| Omyacarb ® 4 (calcium carbonate) | 19 |
| Drakeol 34 (mineral oil) | 25 |
| Advawax ® 280 (ethylene bis stearamide wax) | 6 |
| Total | 100% |

The present invention further provides a method for purging resin deposits from the processing or inner surfaces of polymer processing machinery. The method includes feeding a mixture comprised of a foaming agent, an abrasive, a surfactant, and a binder into the stream of resin in the polymer processing equipment. The mixture is poured from a container directly into a hopper of the polymer processing equipment and is added directly to the stream of resin moving through the barrel of the processing equipment. As the die and other tooling surfaces are thus cleaned in accordance with the invention, the resulting molded articles may have undesirable ingredients attributable to the purge composition. Some of these articles may be recycled in the same or a compatible stream of resin.

As the purge concentrate mixes with the stream of resin, the mixture is heated as it moves along the barrel of the machinery. The binder that holds the components of the purge composition together then melts into the stream of resin, thereby releasing the individual components of the composition into the stream of resin. Incorporation of the purge composition into the melt flow is additionally aided by the presence of the melted binder.

The blowing agent begins to degrade when it reaches the appropriate elevated temperature within the processing machinery. This degradation results in the production of gas bubbles within the melt flow. As the quantity of gas increases within the resin/purge composition mixture, the volume of the mixture expands. The subsequent increase in pressure which results from the expansion of the mixture against the inner surfaces of the machinery causes an increase in the scrubbing action of the mixture which aids in the removal of resin deposits.

The abrasive component of the purge composition is released along with the blowing agent as the binder melts into the stream of resin. Additional scrubbing action is added by the abrasive to the resin mixture, and the abrasive additionally functions as sites of nucleation for the newly forming gas bubbles produced by the degradation of the blowing agent. The small size of the abrasive particles, i.e., less than 1.5 microns, increases the number of potential nucleation sites which results in a more even distribution of the gas bubbles within the melt flow. An even dispersion of the gas within the stream of resin helps to improve the scrubbing action of the purge concentrate along the inner surfaces of the processing machinery. The processing machinery containing the purge composition is operated until the molded composition exiting the machine appears clean, thereby indicating that the internal parts of the machine are clean.

As mentioned above, the normal ratio of endothermic blowing agent to filler is preferably within the range from about 1.5:1 to about 2:1. This same ratio is used for both the low and standard temperature purge compositions. However, the ratio of exothermic blowing agent to filler used in the high temperature purge composition is preferably about 1:1. These ratios are chosen based upon the amount of gas produced by the particular blowing agent employed. More specifically, the exothermic chemistry involved in the degradation of the exothermic blowing agent typically generates 3 to 5 times the amount of gas produced by the endothermic chemistry associated with the degradation of the endothermic blowing agent. Therefore, due to the greater amount of gas generated by the exothermic agent, less blowing agent is required to achieve sufficient gas production.

Typical prior art compositions are prepared or mixed at elevated temperatures in processing equipment such as extruders or two-roll mills. Conventional process equipment cannot be utilized to prepare the compositions of the present invention as the blowing agents would be prematurely activated by the relatively high temperatures. Accordingly, the compositions of the present invention are processed at temperatures less than or equal to about generally 200° F. or about 180° F., desirably less than or equal to about 160° F. and preferably less than or equal to about 140° F.

While the preferred process for blending and preferably pelletizing the compositions of the present invention is described hereinbelow, it is to be understood other processes known in the art and variations of the preferred process can also be utilized. The components of the composition including the abrasive and at least one blowing agent in suitable amounts, minus any liquids and low temperature melting solids, are added to and mixed in a mixer, preferably a high intensity, bowl-type mixer known in the art and available from suppliers such as the Henschel Company of Germany. The mixer can be jacketed and connected to a temperature control system. The mixer has a rotary impeller that mixes as well as agitates the ingredients. The mixing action frictionally raises the temperature of the components. As the components are mixed, the excellent dispersion is provided. When the temperature of the mixer reaches about 100° F., liquid components, if any, are added and the mixing is continued. At about 140° F. the low temperature melting solids, if any, are added to the composition and dispersed therein. The mixture is generally kept from exceeding the above stated temperatures. After a suitable period of mixing time the composition can be further processed immediately, or allowed to set at or below ambient temperature for any length of time. At this time, the composition can generally be described as granular or sand-like. The granular composition is subsequently cold compression molded into particles, preferably pellets. By cold, it is meant that no external heat source such as gas or electricity is utilized in the compression molding process. Thus, the purge composition is processed below the above stated ranges. One such compression molding device is a die and roller type pellet mill which is well known in the art and available from manufacturers such as CPM of San Francisco, Calif. as Model CL series processors. Die and roller pelletizing utilizes compaction and extrusion to produce pellets ranging in length from about 0.015 to about 1 inch, depending on the die utilized. The granular material from a supply hopper is fed continuously in a controlled stream to a pelletizing cavity. Rotation of a die in contact with the rollers cause the same to turn. The material carried by the rotation of the die is compressed between the die and the roll and forced through holes in the die. As pellets of the composition are extruded, a knife or other suitable cutting surface shears the pellets into lengths. Die sizes, and thus the pellets produced thereby may range from about 0.015 inches to about 0.250 inches in diameter with preferred sizes being about 0.0625, 0.125, and 0.150 inches. Typically pellets are formed having a length about two or three times diameter.

The compositions of the present invention can be added to or melt blended with almost any known polymer, resin, or material, both thermoplastic and thermosetting. Examples of thermoplastic polymeric material with which the compositions can be used include but are not limited to ABS resins prepared from acrylonitrile, butadiene and styrene; resins prepared from acrylonitrile, butadiene, styrene and alpha methyl styrene; blends of ABS resins with other thermoplastics such as polyvinylchloride; diene resins; resins prepared from butadiene, styrene and methacrylic acid; resins prepared from acrylonitrile, butadiene, styrene and methyl methacrylate acetal copolymers; acetal resins; acrylic resins and modified acrylic resins, such as, polymethyl methacrylate, copolymers of styrene and methyl methacrylate, copolymers of methyl methacrylate and alpha methyl styrene; the cellulosic plastics, such as, cellulose acetate plastics, cellulose acetate butyrate plastics, cellulose propionate plastics, ethyl cellulose plastics and cellulose nitrate plastics; mixtures of ethyl cellulose plastics and cellulose acetate butyrate; chlorinated polyether; the fluoroplastics such as, polytetrafluoroethylene, polyvinylidene fluoride, the fluorinate ethylene-propylene plastics and the chlorotrifluoroethylene plastics; the phenoxy resins; the polybutadiene-type resins, such as, butadiene-styrene copolymer and polybutadiene; the polycarbonates; polyolefins including polypropylene and polyethylene resins, such as, low-density polyethylene; copolymers of polyethylene with other materials; chlorinated polyethylenes; chlorosulfonated polyethylenes; ethylene vinyl acetate copolymer; ethylene acrylate copolymer; polyphenylene oxide; the polysulfones; the polystyrenes; styrene copolymers; and vinyl polymers and copolymers, such as, polyvinyl chloride, a copolymer of vinyl chloride and vinyl acetate, a copolymer of vinyl chloride, a copolymer of vinyl acetate and vinyl alcohol, a copolymer of vinyl chloride and vinylidene chloride, polyvinyldichloride, and combinations thereof.

Reinforced thermoplastics can be used. The reinforcing is normally done with glass fibers, metal fibers, refractory fibers, and other fibers.

An important aspect of the present invention is that the purge compositions are universal in nature and are compatible or miscible with a wide range of the above polymeric resins.

In accordance with another feature of the invention, the performance of the purge composition may be affected by the ratio of purge concentrate to resin. The purge concentrate is added to a stream of polymer, resin, etc. in an amount generally from about 1 to about 25, 50 or 100 parts, desirably from about 2 to about 20 parts, and preferably from about 3 or 4 to about 10 or 15 parts per 100 parts of resin prior to or during the purging operation. Higher amounts of purge concentrate are generally utilized when a greater level of scrubbing is required for sufficient cleaning of the machinery.

Although preferred embodiments of the invention have been shown and described, it should be understood that various modifications and substitutions, as well as rearrangements and combinations, can be made by those skilled in the art, without departing from the spirit and scope of this invention.

What is claimed is:

1. A composition for purging resin deposits from the processing surfaces of polymer processing machinery, said composition comprising:
a mixture of purging agents, said purging agents comprising a blowing agent comprising an endothermic blowing agent, an exothermic blowing agent, or a combination thereof; an abrasive component; and a surfactant; and
a wax binder that binds said purging agents together in said mixture, said wax binder having a molecular weight of less than about 10,000.

2. A composition according to claim 1, wherein said blowing agent is a polycarbonic acid, coated sodium bicarbonate, coated citric acid, coated monosodium citrate, coated sodium citrate, azodicarbonamide, modified azodicarbonamide, oxybis benzene sulfony hydrazide (OBSH), toluenesulfony-hydrazide (TSH), 5-phenyltetrazole (5-PT), diisopropylhydrazodicarboxylate (DIHC), or dinitrosopentamethylenetetramine (DIHC), or a combination thereof.

3. A composition according to claim 2, wherein said abrasive component is a calcium carbonate, a silica, an alumina, a mica, a sulfate, a sulfide, or a talc, or a combination thereof.

4. A composition according to claim 3, wherein said wax binder is an amide wax, a maleated ethylene wax, a maleated propylene wax, a microcrystalline wax, an oxidized wax, a paraffin wax, a petroleum wax, a polyethylene wax, a PTFE wax, a wax ester, a wax soap, or a polycaprolactone wax, or a combination thereof.

5. A composition according to claim 4, wherein said blowing agent is present in an amount from about 10 to about 80 parts, wherein said abrasive is present in an amount from about 10 to about 75 parts, wherein said surfactant is present in an amount from about 1 to about 30 parts, and wherein said wax binder is present in an amount from about 10 to about 50 parts, all based on 100 parts by weight of said composition.

6. A composition according to claim 5, wherein said surfactant is mineral oil.

7. A composition according to claim 5, wherein said blowing agent is present in an amount from about 25 to about 50 parts, wherein said abrasive is present in an amount from about 25 to about 50 parts, wherein said surfactant is present in an amount from about 2 to about 25 parts, and wherein said binder is present in an amount from about 10 to about 25 parts, based on 100 parts by weight of said composition.

8. A composition according to claim 5, wherein said blowing agent is an endothermic blowing agent.

9. A composition according to claim 5, wherein said blowing agent is an exothermic blowing agent.

10. A composition according to claim 5, wherein said wax binder is ethylene bis stearamide wax, or hydroxy stearamide wax, or a combination thereof, and wherein said abrasive is calcium carbonate.

11. A composition according to claim 1, wherein said composition includes at least one functional compounding additive in an amount from about 1 to about 98 parts by weight based on 100 parts of said composition.

12. A composition according to claim 1, wherein said composition is in a particulate form, and wherein said composition has been formed by cold compression molding.

13. A composition according to claim 12, wherein said particulate form is a pellet, chip, or flake, or a combination thereof.

14. A method for purging resin deposits from the inner surfaces of polymer processing equipment, said method comprising the steps of:
combining a resin with a purging composition comprising a blowing agent, an abrasive component, a surfactant, or a wax binder having a molecular weight of about 10,000; and
processing said resin and said purging composition in said polymer processing equipment to clean the inner surfaces thereof.

15. A method according to claim 14, wherein said blowing agent is present in an amount from about 10 to about 80 parts, wherein said abrasive is present in an amount from about 5 to about 75 parts, wherein said surfactant is present in an amount from about 1 to about 30 parts, and wherein said wax binder is present in an amount from about 10 to about 50 parts, based on 100 parts by weight of said composition.

16. A method according to claim 14, wherein said blowing agent is a polycarbonic acid, coated sodium bicarbonate, coated citric acid, coated monosodium citrate, coated sodium citrate, azodicarbonamide, modified azodicarbonamide, oxybis benzene sulfony hydrazide (OBSH), toluenesulfony-hydrazide (TSH), 5-phenyltetrazole (5-PT), diisopropylhydrazodicarboxylate (DIHC), or dinitrosopentamethylenetetramine (DIHC), or a combination thereof.

17. A method according to claim 14, wherein said abrasive component is a calcium carbonate, a silica, an alumina, a mica, a sulfate, a sulfide, or a talc, or a combination thereof.

18. A method according to claim 14, wherein said wax binder is an amide wax, a maleated ethylene wax, a maleated propylene wax, a microcrystalline wax, an oxidized wax, a paraffin wax, a petroleum wax, a polyethylene wax, a PTFE wax, a wax ester, a wax soap, or a polycaprolactone wax, or a combination thereof.

19. A method according to claim 14, wherein said method includes the step of cold compression molding said purging mixture at a temperature below about 200° F. to produce said purging composition in a particulate form.

20. A method according to claim 19, wherein said particulate form is a pellet, chip, or flake, or a combination thereof.
